(19) United States
(12) Patent Application Publication
(10) Pub. No.: US 2024/0121770 A1
(43) Pub. Date: Apr. 11, 2024

(54) METHOD AND DEVICE FOR SCHEDULING IN WIRELESS COMMUNICATION SYSTEM

(71) Applicant: Samsung Electronics Co., Ltd., Gyeonggi-do (KR)

(72) Inventors: June HWANG, Gyeonggi-do (KR); Soenghun KIM, Gyeonggi-do (KR)

(21) Appl. No.: 18/263,825

(22) PCT Filed: Feb. 4, 2022
(86) PCT No.: PCT/KR2022/001756

§ 371 Date: Aug. 1, 2023

(30) Foreign Application Priority Data
Feb. 5, 2021 (KR) 10-2021-0016702

(51) Int. Cl. H04W 72/12; H04W 72/232

(52) U.S. Cl. CPC H04W 72/12; H04W 72/232

(57) ABSTRACT

The present disclosure relates to a 5^{th} generation (5G) or 6th generation (6G) communication system for supporting a higher data transmission rate. According to an embodiment of the present disclosure, a method performed by a user equipment (UE) in a wireless communication system may be provide. The method may include: receiving, from a base station (BS), configuration information about cross carrier scheduling (CCS); when CCS from a secondary cell (Scell) to a primary cell (Pcell) or a primary Scell (PScell) is configured via the configuration information, monitoring a physical downlink control channel (PDCCH) of the Scell or a PDCCH of the Pcell or the PScell; and identifying scheduling information about the Pcell or the PScell, based on the monitoring.

### TECHNICAL FIELD

The present disclosure relates to a wireless communication system, and more particularly, to a method and apparatus by which a secondary cell (Scell) performs scheduling of a primary cell (Pcell) or a primary Scell (PScell).

### BACKGROUND ART

A 5^{th} generation (5G) mobile communication technology defines a broad frequency band to enable a high date rate and new services, and may be implemented not only in a ‘Sub 6 GHz’ band including 3.5 GHz but also in an ultra high frequency band (‘Above 6 GHz’) referred to as millimeter wave (mmWave) including 28 GHz, 39 GHz, and the like. Also, for a 6th generation (6G) mobile communication technology referred to as a system beyond 5G communication (beyond 5G), in order to achieve a data rate fifty times faster than the 5G mobile communication technology and ultra-low latency one-tenth of the 5G mobile communication technology, implementation of the 6G mobile communication technology in the terahertz band (e.g., the 95 GHz to 3 THz band) is being considered.

In the early phase of the development of the 5G mobile communication technology, in order to support services and satisfy performance requirements of enhanced Mobile BroadBand (eMBB), Ultra Reliable Low Latency Communications (URLLC), and massive Machine-Type Communications (mMTC), there has been ongoing standardization about beamforming and massive multiple input multiple output (MIMO) for mitigating pathloss of radio waves and increasing transmission distances of radio wave in a mmWave band, supporting numerologies (for example, operation of multiple subcarrier spacings) for efficiently utilizing mmWave resources and dynamic operation of slot formats, initial access technologies for supporting multi-beam transmission and broadband, definition and operation of bandwidth part (BWP), new channel coding methods such as a low density parity check (LDPC) code for a large amount of data transmission and a polar code for highly reliable transmission of control information, L2 pre-processing, and network slicing for providing a dedicated network specialized to a specific service.

Currently, there are ongoing discussions about improvement and performance enhancement of initial 5G mobile communication technologies in consideration of services to be supported by the 5G mobile communication technology, and there has been physical layer standardization of technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) that is UE-satellite direct communication for providing coverage in an area in which communication with terrestrial networks is unavailable, and positioning.

Moreover, there has been ongoing standardization of air interface architecture/protocol regarding technologies such as industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR), and standardization of system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

When the 5G mobile communication system is commercialized, connected devices being on a rapidly increasing trend are being predicted to be connected to communication networks, and therefore, it is predicted that enhancement of functions and performance of the 5G mobile communication system and integrated operations of the connected devices are required. To this end, new researches are scheduled for eXtended Reality (XR) for efficiently supporting Augmented Reality (AR), Virtual Reality (VR), Mixed Reality (MR) and the like, 5G performance improvement and complexity reduction by utilizing artificial intelligence (AI) and machine learning (ML), AI service support, metaverse service support, drone communication, and the like.

Also, such development of the 5G mobile communication system will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of the 6G mobile communication technologies and improving system networks, AI-based communication technology for implementing system optimization by utilizing satellites and AI from a design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Solution

The present disclosure provides an apparatus and method for introducing a secondary cell (Scell) that substitutionally performs scheduling of a primary cell (Pcell) or a primary Scell (PScell). Various embodiments of the present disclosure provide a method and apparatus for performing scheduling performance amendment via a Scell in a case where scheduling performance deteriorates due to many terminals physically existing on frequency resources of a Pcell or a PScell.

### DESCRIPTION OF DRAWINGS

FIG. 1 is a diagram illustrating an architecture of a long term evolution (LTE) system.

FIG. 2 is a diagram illustrating a radio protocol architecture of an LTE system.

FIG. 3 is a diagram illustrating an architecture of a next-generation mobile communication system according to an embodiment of the present disclosure.

FIG. 4 is a diagram illustrating a radio protocol architecture of a next-generation mobile communication system according to an embodiment of the present disclosure.

FIG. 5 is a block diagram illustrating an internal configuration of a user equipment (UE) according to an embodiment of the present disclosure.

FIG. 6 is a block diagram illustrating a configuration of a New Radio base station (NR BS) according to an embodiment of the present disclosure.

FIG. 7 is a flowchart of operations of a UE and a BS according to an embodiment of the present disclosure.

FIG. 8 illustrates a flowchart of operations of a UE according to an embodiment of the present disclosure.

FIG. 9 is a block diagram illustrating a structure of a UE according to an embodiment of the present disclosure.

FIG. 10 is a block diagram illustrating a structure of a BS according to an embodiment of the present disclosure.

### MODE FOR INVENTION

Advantages and features of the present disclosure and methods of accomplishing the same may be understood more readily by reference to the following detailed descriptions of embodiments and accompanying drawings. However, the present disclosure may be embodied in many different forms and should not be construed as being limited to the embodiments set forth herein. Rather, these embodiments are provided so that the present disclosure will be thorough and complete and will fully convey the concept of the present disclosure to one of ordinary skill in the art, and the present disclosure will only be defined by the appended claims. Throughout the specification, like reference numerals denote like elements.

Here, it will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed by the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory produce an article of manufacture including instruction means that perform the functions specified in the flowchart block(s). The computer program instructions may also be loaded onto the computer or other programmable data processing apparatus to cause a series of operations to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “unit”, as used in the present embodiment, refers to a software or hardware component, such as field-programmable gate array (FPGA) or application-specific integrated circuit (ASIC), which performs certain tasks. However, the term “unit” does not mean to be limited to software or hardware. A “unit” may be configured to be in an addressable storage medium or configured to operate one or more processors. Thus, a “unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and “units” may be combined into fewer components and “units” or may be further separated into additional components and “units”. Further, the components and “units” may be implemented to operate one or more central processing units (CPUs) in a device or a secure multimedia card. Also, a “unit” may include one or more processors in embodiments.

In the description of the present disclosure, detailed descriptions of the related art are omitted when it is deemed that they may unnecessarily obscure the essence of the present disclosure. Hereinafter, embodiments of the present disclosure will be described in detail with reference to accompanying drawings.

Hereinafter, terms identifying an access node, terms indicating network entities, terms indicating messages, terms indicating an interface between network entities, and terms indicating various pieces of identification information, as used in the following description, are exemplified for convenience of descriptions. Accordingly, the present disclosure is not limited to the terms to be described below, and other terms indicating objects having equal technical meanings may be used.

For convenience of descriptions, in the present disclosure, terms and names or modifications of the terms and names defined in the 3^{rd} Generation Partnership Project Long Term Evolution (3GPP LTE) standard are used. However, the present disclosure is not limited to the terms and names, and may also be applied to systems following other standards. In the present disclosure, an evolved node B (eNB) may be interchangeably used with a next-generation node B (gNB) for convenience of explanation. That is, a base station (BS) described by an eNB may represent a gNB. Also, the term “terminals” may refer to not only mobile phones, narrowband Internet of Things (NB-IoT) devices, and sensors but also other wireless communication devices.

Hereinafter, a base station is an entity that allocates resources to a terminal, and may be at least one of a gNode B, an eNode B, a Node B, a BS, a radio access unit, a BS controller, or a node on a network. A terminal may include a user equipment (UE), a mobile station (MS), a cellular phone, a smartphone, a computer, or a multimedia system capable of performing a communication function. However, the present disclosure is not limited to the above example.

In particular, the present disclosure may be applied to 3GPP NR (5th generation mobile communication standards). Also, the present disclosure is applicable to intelligent services (e.g., smart home, smart building, smart city, smart car or connected car, health care, digital education, retail, security, and safety services) based on 5G communication technology and Internet of things (IoT) technology. In the present disclosure, an eNB may be interchangeably used with a gNB for convenience of explanation. That is, a BS described by an eNB may represent a gNB. Also, the term “terminals” may refer to not only mobile phones, narrowband NB-IoT devices, and sensors but also other wireless communication devices.

Wireless communication systems that provided voice-based services in the early stages are now being developed to be broadband wireless communication systems providing high-speed and high-quality packet data services according to communication standards such as high speed packet access (HSPA), long term evolution (LTE) or evolved universal terrestrial radio access (E-UTRA), LTE-advanced (LTE-A), LTE-Pro of 3GPP, high rate packet data (HRPD), ultra mobile broadband (UMB) of 3GPP2, and 802.16e of the Institute of Electrical and Electronics Engineers (IEEE).

As a representative example of the broadband wireless communication systems, LTE systems employ orthogonal frequency division multiplexing (OFDM) for a downlink (DL) and employs single carrier-frequency division multiple access (SC-FDMA) for an uplink (UL). The UL refers to a radio link for transmitting data or a control signal from a terminal (e.g., a UE or an MS) to a base station (e.g., an eNB or a BS), and the DL refers to a radio link for transmitting data or a control signal from the base station to the terminal. The above-described multiple access schemes identify data or control information of each user in a manner that time-frequency resources for carrying the data or control information of each user are allocated and managed not to overlap each other, that is, to achieve orthogonality therebetween.

As post-LTE communication systems, i.e., 5G communication systems need to support services capable of freely reflecting and simultaneously satisfying various requirements of users, service providers, and the like. Services considered for the 5G systems include enhanced mobile broadband (eMBB), massive machine-type communication (mMTC), ultra-reliability low-latency communication (URLLC) services, or the like.

According to some embodiments, the eMBB aims to provide an improved data rate than a data rate supported by the legacy LTE, LTE-A, or LTE-Pro. For example, in a 5G communication system, the eMBB should be able to provide a peak data rate of 20 Gbps in a DL and a peak data rate of 10 Gbps in an UL at one BS. Also, the 5G communication system should be able to provide a peak data rate and simultaneously provide an increased user-perceived data rate of a terminal. In order to satisfy such requirements, there is a need, in the 5G communication system, for improvement in various transmission/reception technologies including an improved multiple-input multiple-output (MIMO) transmission technology. Also, a data rate required in the 5G communication system may be satisfied by using a frequency bandwidth wider than 20 MHz in the 3 GHz to 6 GHz or 6 GHz or more frequency band, instead of the legacy LTE transmitting a signal by using maximum 20 MHz in the 2 GHz band.

Simultaneously, the mMTC is being considered to support application services such as IoT in 5G communication systems. In order to efficiently provide the IoT, the mMTC may require the support for a large number of terminals in a cell, improved coverage for a terminal, improved battery time, reduced costs of a terminal, and the like. Because the IoT is attached to various sensors and various devices to provide a communication function, the mMTC should be able to support a large number of terminals (e.g., 1,000,000 terminals/km 2) in a cell. Also, because a terminal supporting the mMTC is likely to be located in a shadow region failing to be covered by the cell, such as the basement of a building, due to the characteristics of the service, the terminal may require wider coverage than other services provided by the 5G communication systems. The terminal supporting the mMTC should be configured as a low-cost terminal and may require a very long battery life time such as 10 to 15 years because it is difficult to frequently replace the battery of the terminal.

Lastly, the URLLC refers to cellular-based wireless communication services used for mission-critical purposes such as services for remote control of robots or machinery, industrial automation, unmanned aerial vehicles, remote health care, emergency alerts, and the like. Therefore, the URLLC should provide communications providing very low latency (ultra low latency) and very high reliability (ultra high reliability). For example, a service supporting the URLLC should satisfy air interface latency of less than 0.5 milliseconds, and simultaneously has a requirement for a packet error rate of 10-5 or less. Thus, for the service supporting the URLLC, the 5G system should provide a transmit time interval (TTI) smaller than other services and may simultaneously have a design requirement for allocating wide resources in a frequency band so as to ensure reliability of communication links.

The three services considered in the 5G communication system, i.e., the eMBB, the URLLC, and the mMTC, may be multiplexed and transmitted in one system. Here, in order to satisfy different requirements of the services, the services may use different transceiving schemes and different transceiving parameters. However, the above-described mMTC, URLLC, and eMBB services are merely examples and the types of services to which the present disclosure is applicable are not limited thereto.

Although LTE, LTE-A, LTE Pro, or 5G (or New Radio (NR), next-generation mobile communication) are mentioned as examples in the following description, embodiments of the present disclosure may also be applied to other communication systems having similar technical backgrounds or channel types. Furthermore, the embodiments of the present disclosure may also be applied to other communication systems through partial modification without greatly departing from the scope of the present disclosure based on determination by one of ordinary skill in the art. Hereinafter, operational principles of the present disclosure will be described in detail with reference to accompanying drawings. In the following descriptions of the present disclosure, well-known functions or configurations are not described in detail because they would obscure the present disclosure with unnecessary details. The terms used in the specification are defined in consideration of functions used in the present disclosure, and can be changed according to the intent or commonly used methods of users or operators. Accordingly, definitions of the terms are understood based on the entire descriptions of the present specification.

Hereinafter, terms identifying an access node, terms indicating network entities, terms indicating messages, terms indicating an interface between network entities, and terms indicating various pieces of identification information, as used in the following description, are exemplified for convenience of descriptions. Accordingly, the present disclosure is not limited to terms to be described below, and other terms indicating objects having equal technical meanings may be used.

For convenience of descriptions, the present disclosure uses terms and names defined in the 3^{rd} Generation Partnership Project (3GPP) long term evolution (LTE) standards. However, the present disclosure is not limited to these terms and names, and may be equally applied to communication systems conforming to other standards.

According to an embodiment of the present disclosure, provided is a method performed by a UE in a wireless communication system, the UE being served by a primary cell (Pcell), a primary secondary cell (PScell), and one or more secondary cells (Scells). The method may include: transmitting UE capability information to a BS; receiving information associated with cross carrier scheduling from the BS; monitoring, based on the received information, a control channel associated with a Scell so as to obtain scheduling information associated with the Pcell or the PScell; and performing data communication associated with the Pcell or the PScell, based on the scheduling information.

According to various embodiments of the present disclosure, a Scell that substitutionally performs scheduling of a Pcell or a PScell allows a UE to perform monitoring associated with a UE specific search space (USS) and a common search space (CSS) necessary for the UE to perform an operation corresponding to each cell, such that it is possible to prevent scheduling performance associated with the Pcell or the PScell from deteriorating due to multiple UEs existing in the Pcell or the PScell.

A disclosed embodiment provides an apparatus and method for effectively providing a service in a mobile communication system.

A signal codebook necessary for a UE to schedule a P(S)cell via a Scell may be introduced, necessary scheduling information may be obtained via the Scell by separately configuring a UE specific search space and a common search space and changing a structure of downlink control information (DCI) according to the signal, and P(S)cell scheduling of the UE may be performed according to a state of the corresponding scheduling Scell.

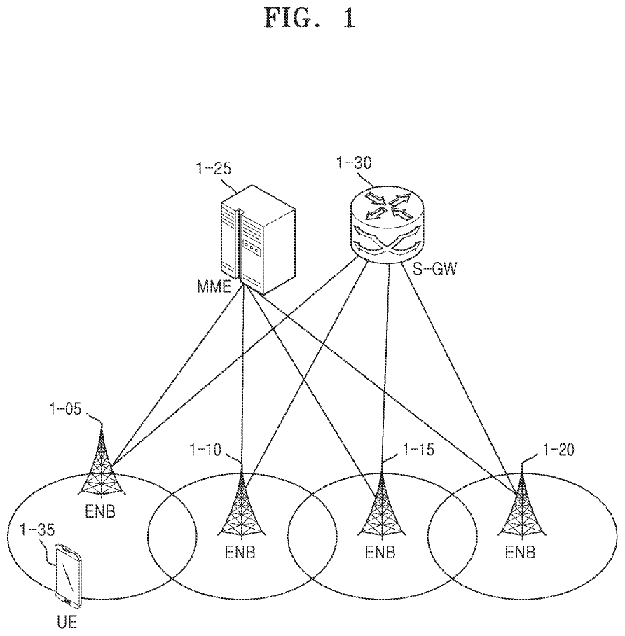

FIG. 1 is a diagram illustrating an architecture of a LTE system.

Referring to FIG. 1, a radio access network (RAN) of the LTE system includes a plurality of next-generation BSs (or evolved nodes B (ENBs), nodes B or BSs) 1-05, 1-10, 1-15, and 1-20, a mobility management entity (MME) 1-25, and a serving-gateway (S-GW) 1-30. A UE (or a terminal) 1-35 may access an external network via the eNB 1-05, 1-10, 1-15, or 1-20 and the S-GW 1-30.

In FIG. 1, the eNB 1-05, 1-10, 1-15, or 1-20 may correspond to a legacy node B of a universal mobile telecommunications system (UMTS). The eNB may be connected to the UE 1-35 via wireless channels and may perform complex functions, compared to the legacy node B. In the LTE system, all user traffic data including real-time services such as voice over Internet protocol (VoIP) may be serviced via shared channels. Therefore, an entity for performing scheduling by collating state information of UEs, the state information including buffer state information, available transmit power state information, and channel state information, may be required and the eNB 1-05, 1-10, 1-15, or 1-20 may operate as such an entity. One eNB may generally control a plurality of cells. For example, the LTE system may use a radio access technology such as orthogonal frequency division multiplexing (OFDM) at a bandwidth of 20 MHz so as to achieve a data rate of 100 Mbps. Also, the LTE system may apply adaptive modulation & coding (AMC) to determine a modulation scheme and a channel coding rate in accordance with a channel state of the UE. The S-GW 1-30 may be an entity for providing data bearers, and may generate or remove the data bearers according to the control by the MME 1-25. The MME may be an entity for performing a mobility management function and various control functions on the UE and may be connected to the plurality of eNBs.

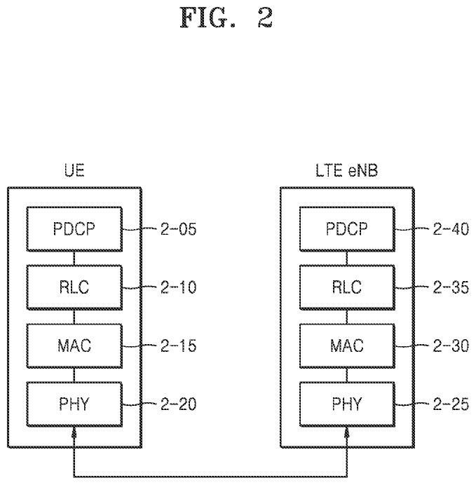

FIG. 2 is a diagram illustrating a radio protocol architecture of an LTE system.

Referring to FIG. 2, the radio protocol architecture of the LTE system may include packet data convergence protocol (PDCP) layers 2-05 and 2-40, radio link control (RLC) layers 2-10 and 2-35, media access control (MAC) layers 2-15 and 2-30, and physical (PHY) layers 2-20 and 2-25 respectively for a UE and a LTE eNB The PDCP layer may be in charge of Internet protocol (IP) header compression/decompression. Main functions of the PDCP layer may be summarized as shown below.
Header compression and decompression: Robust Header Compression (ROHC) only
Transfer of user data
In-sequence delivery of upper layer Protocol Data Units (PDUs) at Packet Data Convergence Protocol (PDCP) re-establishment procedure for Radio Link Control (RLC) Acknowledged Mode (AM)
For split bearers in Dual Connectivity (DC) (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink.

The RLC layer 2-10 or 2-35 may perform an automatic repeat request (ARQ) operation by reconfiguring PDCP PDUs to appropriate sizes. Main functions of the RLC layer may be summarized as shown below.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC Service Data Unit (SDU) discard (only for Unacknowledged mode (UM) and AM data transfer)
RLC re-establishment

The MAC layer 2-15 or 2-30 may be connected to a plurality of RLC layers configured for one UE, and may multiplex RLC PDUs into a MAC PDU and demultiplex the RLC PDUs from the MAC PDU. Main functions of the MAC layer may be summarized as shown below.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through Hybrid Automatic Repeat Request (HARQ)
Priority handling between logical channels of one UE
Priority handling between UEs by means of dynamic scheduling
Multimedia Broadcast and Multicast Service (MBMS) service identification
Transport format selection
Padding

The PHY layer 2-20 or 2-25 may channel-code and modulate upper layer data into OFDM symbols and may transmit the OFDM symbols via a wireless channel, or may demodulate OFDM symbols received via a wireless channel and may channel-decode and transmit the OFDM symbols to an upper layer.

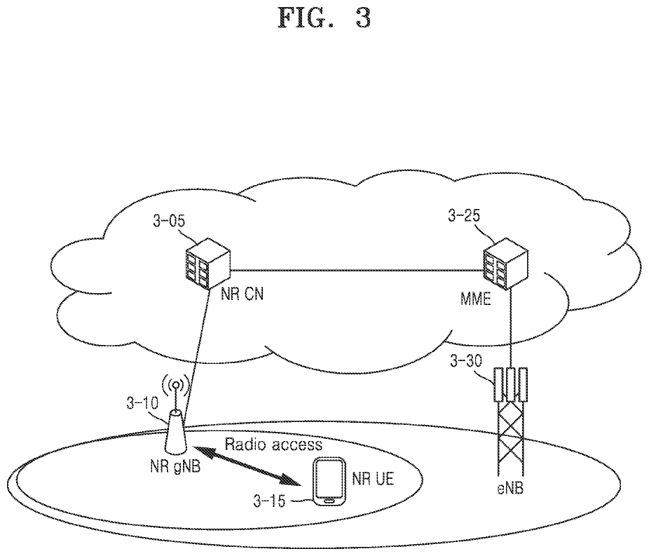

FIG. 3 is a diagram illustrating an architecture of a next-generation mobile communication system according to an embodiment of the present disclosure.

Referring to FIG. 3, a radio access network of the next-generation mobile communication system (e.g., an NR or 5G system) may include a next-generation BS (a new radio node B, e.g., NR gNB or NR BS) 3-10 and a new radio core network (NR CN) 3-05. An NR UE (or NR terminal) 3-15 may access an external network via the NR gNB 3-10 and the NR CN 3-05.

In FIG. 3, the NR gNB 3-10 may correspond to an eNB of a legacy LTE system. The NR gNB may be connected to the NR UE 3-15 via wireless channels and may provide superior services compared to a legacy node B. In the next-generation mobile communication system, all user traffic data may be serviced via shared channels. Therefore, an entity for performing scheduling by collating, for example, buffer state information of UEs, available transmit power state information, and channel state information may be required and the NR gNB 3-10 may operate as such an entity. One NR gNB may control a plurality of cells. The next-generation mobile communication system may have a bandwidth greater than the maximum bandwidth of the LTE system so as achieve an ultrahigh data rate. Also, a beamforming technology may be additionally associated with OFDM as a radio access technology. Also, AMC may also be applied to determine a modulation scheme and a channel coding rate in accordance with a channel state of the NR UE. The NR CN 3-05 may perform functions such as mobility support, bearer configuration, quality of service (QoS) configuration, and the like. The NR CN may be an entity for performing a mobility management function and various control functions on the NR UE and may be connected to a plurality of BSs. Also, the next-generation mobile communication system may cooperate with the legacy LTE system, and the NR CN 3-05 may be connected to an MME 3-25 via a network interface. The MME may be connected to a legacy eNB 3-30.

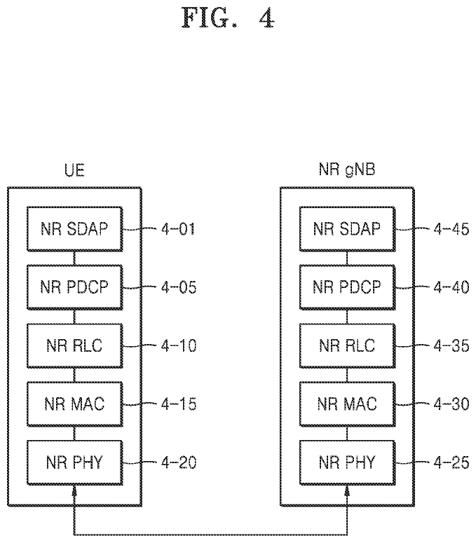

FIG. 4 is a diagram illustrating a radio protocol architecture of a next-generation mobile communication system according to an embodiment of the present disclosure.

Referring to FIG. 4, a radio protocol of the next-generation mobile communication system may include NR Service Data Adaptation Protocol (SDAP) layers 4-01 and 4-45, NR PDCP layers 4-05 and 4-40, NR RLC layers 4-10 and 4-35, NR MAC layers 4-15 and 4-30, and NR PHY layers 4-20 and 4-25 respectively for a UE and an NR gNB.

Main functions of the NR SDAP layer 4-01 or 4-45 may include some of the following functions.
Transfer of user plane data
Mapping between a QoS flow and a DRB for both downlink (DL) and uplink (UL)
Marking QoS flow identifier (ID) in both DL and UL packets
Reflective QoS flow to DRB mapping for the UL SDAP PDUs.

With regard to the NR SDAP layer, the UE may be configured with information about whether to use a header of the NR SDAP layer or to use functions of the NR SDAP layer by using a radio resource control (RRC) message per PDCP layer, per bearer, or per logical channel, the RRC message being received from the NR gNB. When the SDAP header is configured, a 1-bit non access stratum (NAS) reflective QoS indicator and a 1-bit access stratum (AS) reflective QoS indicator of the SDAP header may be used to indicate the UE to update or reconfigure UL and DL QoS flow and data bearer mapping information. The SDAP header may include QoS flow ID information indicating QoS. QoS information may be used as data processing priority information or scheduling information for appropriately supporting a service.

Main functions of the NR PDCP layer 4-05 or 4-40 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink.

In the descriptions above, the reordering function of the NR PDCP layer may indicate a function of reordering PDCP PDUs received from a lower layer, on a PDCP sequence number (SN) basis. The reordering function of the NR PDCP layer may include a function of delivering the reordered data to an upper layer in order or may include a function of immediately delivering the reordered data out of order, may include a function of recording missing PDCP PDUs by reordering the received PDCP PDUs, may include a function of reporting status information of the missing PDCP PDUs to a transmitter, and a function of requesting to retransmit the missing PDCP PDUs.

Main functions of the NR RLC layer 4-10 or 4-35 may include at least some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

In the descriptions above, the in-sequence delivery function of the NR RLC layer may indicate a function of delivering RLC SDUs received from a lower layer, to an upper layer in order. When a plurality of RLC SDUs segmented from one RLC SDU are received, the in-sequence delivery function of the NR RLC layer may include a function of reassembling the RLC SDUs and delivering the reassembled RLC SDU.

The in-sequence delivery function of the NR RLC layer may include a function of reordering received RLC PDUs on a RLC SN or PDCP SN basis, may include a function of recording missing RLC PDUs by reordering the received RLC PDUs, may include a function of reporting status information of the missing RLC PDUs to a transmitter, and may include a function of requesting to retransmit the missing RLC PDUs.

The in-sequence delivery function of the NR RLC layer may include a function of delivering only RLC SDUs prior to a missing RLC SDU, to an upper layer in order when the missing RLC SDU exists.

The in-sequence delivery function of the NR RLC layer may include a function of delivering all RLC SDUs received before a timer starts, to an upper layer in order when a certain timer is expired, even when a missing RLC SDU exists.

The in-sequence delivery function of the NR RLC layer may include a function of delivering all RLC SDUs received up to a current time, to an upper layer in order when a certain timer is expired, even when a missing RLC SDU exists.

The NR RLC layer may process the RLC PDUs in order of reception and may deliver the RLC PDUs to the NR PDCP layer, regardless of SNs (out-of-sequence delivery).

When the NR RLC layer receives a segment, the NR RLC layer may reassemble the segment with other segments stored in a buffer or subsequently received, into a whole RLC PDU and may deliver the RLC PDU to the NR PDCP layer.

The NR RLC layer may not have a concatenation function, and the NR MAC layer may perform the function or the concatenation function may be replaced with a multiplexing function of the NR MAC layer.

In the descriptions above, the out-of-sequence delivery function of the NR RLC layer may refer to a function of directly delivering RLC SDUs received from a lower layer, to an upper layer out of order. The out-of-sequence delivery function of the NR RLC layer may include a function of reassembling a plurality of RLC SDUs segmented from one RLC SDU and delivering the reassembled RLC SDU when the segmented RLC SDUs are received. The out-of-sequence delivery function of the NR RLC layer may include a function of recording missing RLC PDUs by storing RLC SNs or PDCP SNs of received RLC PDUs and reordering the received RLC PDUs.

The NR MAC layer 4-15 or 4-30 may be connected to a plurality of NR RLC layers configured for one UE, and main functions of the NR MAC layer may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layer 4-20 or 4-25 may channel-code and modulate upper layer data into OFDM symbols and transmit the OFDM symbols through a wireless channel, or may demodulate OFDM symbols received through a wireless channel and channel-decode and deliver the OFDM symbols to an upper layer.

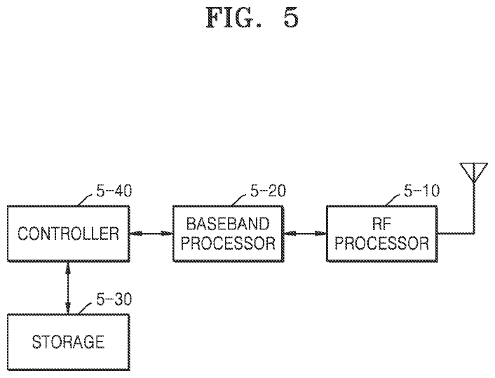

FIG. 5 is a block diagram illustrating an internal configuration of a UE according to an embodiment of the present disclosure.

Referring to the drawing, the UE includes a radio frequency (RF) processor 5-10, a baseband processor 5-20, a storage 5-30, and a controller 5-40.

The RF processor 5-10 performs functions of transmitting and receiving signals via radio channels, such as band conversion and amplification of the signals. That is, the RF processor 5-10 up-converts a baseband signal provided from the baseband processor 5-20, into an RF band signal and then transmits the RF band signal via an antenna, and down-converts an RF band signal received via the antenna, into a baseband signal. For example, the RF processor 5-10 may include a transmission filter, a reception filter, an amplifier, a mixer, an oscillator, a digital-to-analog convertor (DAC), an analog-to-digital convertor (ADC), or the like. Although only one antenna is illustrated in the drawing, the UE may include a plurality of antennas. Also, the RF processor 5-10 may include a plurality of RF chains. In addition, the RF processor 5-10 may perform beamforming. For beamforming, the RF processor 5-10 may respectively adjust phases and intensities of signals to be transmitted or received via a plurality of antennas or antenna elements. Also, the RF processor 5-10 may perform a MIMO operation and may receive a plurality of layers in the MIMO operation.

The baseband processor 5-20 converts between a baseband signal and a bitstream based on physical entity specifications of a system. For example, for data transmission, the baseband processor 5-20 generates complex symbols by encoding and modulating a transmission bitstream. For data reception, the baseband processor 5-20 reconstructs a received bitstream by demodulating and decoding a baseband signal provided from the RF processor 5-10. For example, according to an OFDM scheme, for data transmission, the baseband processor 5-20 generates complex symbols by encoding and modulating a transmit bitstream, maps the complex symbols to subcarriers, and then configures OFDM symbols by performing inverse fast Fourier transform (IFFT) and cyclic prefix (CP) insertion. For data reception, the baseband processor 5-20 segments a baseband signal provided from the RF processor 5-10, into OFDM symbol units, reconstructs signals mapped to subcarriers by performing fast Fourier transform (FFT), and then reconstructs a received bitstream by demodulating and decoding the signals.

The baseband processor 5-20 and the RF processor 5-10 transmit and receive signals as described above. Accordingly, the baseband processor 5-20 and the RF processor 5-10 may also be called a transmitter, a receiver, a transceiver, or a communicator. In addition, at least one of the baseband processor 5-20 and the RF processor 5-10 may include a plurality of communication modules to support a plurality of different radio access technologies. Also, at least one of the baseband processor 5-20 and the RF processor 5-10 may include different communication modules to process signals of different frequency bands. For example, the different radio access technologies may include a wireless LAN (e.g.: IEEE 802.11), a cellular network (e.g.: LTE), or the like. Also, the different frequency bands may include a super-high frequency (SHF) (e.g., 2.NRHz, NRhz) band and a millimeter wave (mmWave) (e.g., 60 GHz) band.

The storage 5-30 stores basic programs, application programs, and data, e.g., configuration information, for operations of the UE. In particular, the storage 5-30 may store information associated with a second access node that performs wireless communication by using a second radio access technology. The storage 5-30 provides the stored data according to the request by the controller 5-40.

The controller 5-40 controls overall operations of the UE. For example, the controller 5-40 transmits and receives signals through the baseband processor 5-20 and the RF processor 5-10. Also, the controller 5-40 records and reads data on or from the storage 5-40. To this end, the controller 5-40 may include at least one processor. For example, the controller 5-40 may include a communication processor (CP) for controlling communications and an application processor (AP) for controlling an upper layer such as an application program.

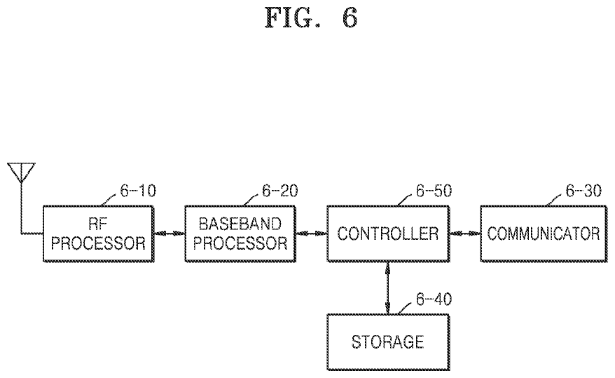

FIG. 6 is a block diagram illustrating a configuration of an NR BS according to an embodiment of the present disclosure.

As illustrated in the drawing, the BS includes a RF processor 6-10, a baseband processor 6-20, a backhaul communicator 6-30, a storage 6-40, and a controller 6-50.

The RF processor 6-10 performs functions of transmitting and receiving signals via radio channels, e.g., band conversion and amplification of the signals. That is, the RF processor 6-10 up-converts a baseband signal provided from the baseband processor 6-20, into an RF band signal and then transmits the RF band signal via an antenna, and down-converts an RF band signal received via an antenna, into a baseband signal. For example, the RF processor 6-10 may include a transmission filter, a reception filter, an amplifier, a mixer, an oscillator, a DAC, an ADC, or the like. Although only one antenna is illustrated in the drawing, the first access node may include a plurality of antennas. Also, the RF processor 6-10 may include a plurality of RF chains. In addition, the RF processor 6-10 may perform beamforming. For beamforming, the RF processor 6-10 may respectively adjust phases and intensities of signals to be transmitted or received via a plurality of antennas or antenna elements. The RF processor may perform a DL MIMO operation by transmitting one or more layers.

The baseband processor 6-20 converts between a baseband signal and a bitstream, based on physical entity specifications of a first radio access technology. For example, for data transmission, the baseband processor 6-20 generates complex symbols by encoding and modulating a transmission bitstream. Also, for data reception, the baseband processor 6-20 reconstructs a received bitstream by demodulating and decoding a baseband signal provided from the RF processor 6-10. For example, according to an OFDM scheme, for data transmission, the baseband processor 6-20 generates complex symbols by encoding and modulating a transmission bitstream, maps the complex symbols to subcarriers, and then configures OFDM symbols by performing IFFT and CP insertion. Also, for data reception, the baseband processor 6-20 segments a baseband signal provided from the RF processor 6-10, into OFDM symbol units, reconstructs signals mapped to subcarriers by performing FFT, and then reconstructs a received bitstream by demodulating and decoding the signals. The baseband processor 6-20 and the RF processor 6-10 transmits and receives signals as described above. Accordingly, the baseband processor 6-20 and the RF processor 6-10 may also be called a transmitter, a receiver, a transceiver, a communicator, or a wireless communicator.

The backhaul communicator 6-30 provides an interface for communicating with other nodes in a network. That is, the backhaul communicator 6-30 converts a bitstream, which is transmitted from the primary BS to another node, for example, a secondary BS, a core network, etc. into a physical signal, and converts a physical signal, which is received from another node, into a bitstream.

The storage 6-40 stores basic programs, application programs, and data, e.g., configuration information, for operations of a primary BS. In particular, the storage 6-40 may store information about bearers allocated for a connected UE and measurement results reported from the connected UE. Also, the storage 6-40 may store criteria information used to determine whether to provide or release dual connectivity to or from the UE. The storage 6-40 provides the stored data according to the request by the controller 6-50.

The controller 6-50 controls overall operations of the primary BS. For example, the controller 6-50 transmits and receives signals via the baseband processor 6-20 and the RF processor 6-10, or the backhaul communicator 6-30. Also, the controller 6-50 records and reads data on or from the storage 6-40. To this end, the controller 6-50 may include at least one processor.

Terms used in the descriptions below may indicate the followings.
Pcell: primary cell, primary cell
PSCell: Primary Scell, primary Scell
SCell: secondary cell
CSS: common search space
USS: UE specific search space
DCI: downlink Control Information
RNTI: radio network temporary identifier
PDCCH: physical downlink control channel
P(S)cell: Pcell or PScell

Dynamic spectrum sharing (DSS) refers to a technology for co-existing an LTE UE and a 5G UE in a same frequency band by controlling an LTE signal not to overlap a 5G signal. When the DSS is supported, an LTE service and a 5G service may co-exist in the same frequency band, and the number of UEs requesting scheduling may increase in the frequency band where the LTE service and the 5G service co-exist. If a large number of UEs existing in the frequency band where the LTE service and the 5G service co-exist monitor a control channel associated with a P(S)cell for resource allocations, efficiency in scheduling may deteriorate. Therefore, there is a need for a method of increasing efficiency in scheduling by allowing an Scell to perform a part of scheduling performed by the P(S)cell, the Scell belonging to carrier aggregation (CA) associated with the P(S)cell.

[Operating Method for Activation/Deactivation of P(S)Cell Scheduling Scell]

A P(S)cell scheduling Scell indicates a Scell that substitutionally performs scheduling of a P(S)cell, the scheduling of the P(S)cell has to be always provided via the P(S)cell or the P(S)cell scheduling Scell, and thus, if a BS attempts to operate the P(S)cell scheduling Scell, the BS should not deactivate the corresponding Scell. In this regard, the BS may perform a method as below.

According to an embodiment, with respect to activation/deactivation of the P(S)cell scheduling Scell, the BS may not deactivate the P(S)cell scheduling Scell via configuration. For the P(S)cell scheduling Scell, the BS may set a Scell deactivation timer (sCellDeactivationTimer) of the corresponding Scell to absent. When a signal indicating absent to the timer is received, a UE may apply infinity as a timer value to set sCellDeactivationTimer to absent.

For example, sCellDeactivationTimer may be set for each serving cell, and if sCellDeactivationTimer for a Scell expires, the UE may autonomously deactivate the Scell. When the BS does not set sCellDeactivationTimer for the P(S)cell scheduling Scell, the P(S)cell scheduling Scell recognizes a value of a deactivation timer as infinity, so that a deactivation situation due to an expiry of the timer does not occur.

According to another embodiment, if the P(S)cell scheduling Scell is deactivated due to an expiry of a timer while the P(S)cell scheduling Scell simultaneously performs scheduling of a P(S)cell and its (the P(S)cell scheduling Scell) own scheduling, there are two methods by which the P(S)cell performs scheduling used to be performed by the P(S)cell scheduling Scell.

According to a first method, a UE autonomously performs an operation in which, when the P(S)cell scheduling Scell is deactivated due to an expiry of a timer, the UE may autonomously stop scheduling of the P(S)cell scheduling Scell and the P(S)cell may enable scheduling used to be performed by the P(S)cell scheduling Scell.

According to a second method, it is a BS signaling method by which, when a network recognizes a deactivation timer expiry of the P(S)cell scheduling Scell and the deactivation timer expires, the network may perform signaling to allow the P(S)cell to perform again scheduling used to be performed by the P(S)cell scheduling Scell. Here, the BS may signal an RRC message from which a cross carrier scheduling config field of the P(S)cell is removed, and thus, may enable scheduling of the P(S)cell. By doing so, in activation of the P(S)cell scheduling Scell, the P(S)cell scheduling Scell may perform scheduling of itself and the P(S)cell, and in deactivation of the P(S)cell scheduling Scell, the P(S)cell may perform scheduling of the P(S)cell. In a legacy situation, the P(S)cell has to perform scheduling of itself and/or a Scell in any case, but, according to an embodiment of the present disclosure, when the P(S)cell scheduling Scell is in an active state, the BS may not schedule the P(S)cell.

In other case, when a Scell is in an activation state and the BS attempts to indicate the Scell to schedule a P(S)cell, the BS may indicate the Scell to perform scheduling of the P(S)cell, via an RRC message as described below in [Method of configuring cross carrier scheduling in or after Scell addition].

With respect to the restriction above, the P(S)cell may be scheduled via a PDCCH of itself (a case where cross carrier scheduling is not configured, or even it is configured, the P(S)cell performs scheduling of itself and a specific serving Scell), or may be scheduled via a PDCCH of the P(S)cell scheduling Scell (a case where it is configured that scheduling is performed by using a Scell in cross carrier scheduling).

[PDCCH Monitoring Offloading Methods]

According to an embodiment of the present disclosure, in order to distribute a scheduling task of a P(S)cell and a P(S)cell scheduling Scell, a PDCCH monitoring task may be distributed as below.

[PDCCH Monitoring Offloading Option 1.]

According to an embodiment, a BS may offload only a USS to the P(S)cell scheduling Scell. That is, a UE may perform downlink control information (DCI) and radio network temporary identifier (RNTI) monitoring for a CSS, and a part of DCI and RNTI monitoring for a USS in a P(S)cell. The UE may perform a remaining part of the DCI and RNTI monitoring for the USS in a P(S)cell scheduling Scell. In this case, as DCI type 1_0 and 0_0 do not have a carrier indicator field (CIF), the UE may schedule both of the P(S)cell and the P(S)cell scheduling Scell. In this case, there may be operational restrictions below according to DCI types.

DCI type 1_1, 0_1: These DCIs each have a legacy CIF. Accordingly, for cross carrier scheduling in the P(S)cell scheduling Scell, the UE has to perform PDCCH monitoring for the DCI types. When DCI of the type is received while the UE performs monitoring, the UE may determine, by checking an indicator of a CIF included therein, whether corresponding control information is for the P(S)cell or the P(S)cell scheduling Scell.

DCI type 1_0, 0_0: These DCI types do not have a CIF. Therefore, DCI associated with DCI type 1_0 and DCI type 0_0 may be transmitted in both the P(S)cell and the P(S)cell scheduling Scell, and the UE has to monitor all DC's associated with DCI type 1_0 and DCI type 0_0 in the P(S)cell and the P(S)cell scheduling Scell. DCI associated with DCI type 1_0 and DCI type 0_0 for a random access may be used in the P(S)cell, and DCI of these types may be used for PDSCH/PUSCH scheduling of a cell itself in the P(S)cell scheduling Scell.

Table 1 below indicates RNTIs the UE has to monitor to obtain control information that may be transmitted from DCI type for each search space and DCI corresponding to the DCI type which may be transmitted in the P(S)cell and the P(S)cell scheduling Scell when the P(S)cell scheduling Scell is activated. The UE has to monitor an RNTI for application of information that may be transmitted with a DCI format and a DCI type which correspond to Table 1, in each cell (P(S)cell and P(S)cell scheduling Scell). Also, as indicated in Table 1, each DCI format and RNTI may correspond to a CSS and a USS.

TABLE 1

| PCell | | | P(S)Cell scheduling SCell | | |
|---|---|---|---|---|---|
| SS | DCI format | RNTI | SS | DCI format | RNTI |
| CSS/USS | 1_0 | RA-RNTI, | USS | 1_0 (PDSCH, | RA-RNTI, P-RNTI, |
| | | P-RNTI, | | fallback ) | SI-RNTI, C-RNTI, |
| | | SI-RNTI, | | | CS-RNTI, |
| | | C-RNTI, | | | MCS-RNTI |
| | | CS-RNTI, | | | |
| | | MCS-RNTI | | | |
| CSS/USS | 0_0 | T C-RNTI, | USS | 0_0(PUSCH, | T C-RNTI, C-RNTI, |
| | | C-RNTI, | | fallback) | CS-RNTI, |
| | | CS-RNTI, | | | MCS-RNTI |
| | | MCS-RNTI | | | |
| CSS | 2_0 (slot format | SFI-RNTI | USS | 1_1, (PDSCH,non | C-RNTI |
| | indication) | | | fallback ) | |
| CSS | 2_1 (preemption | INT-RNTI | uss | 0_1(PUSCH, non | C-RNTI, CS-RNTI, |
| | indication) | | | fallback) | MCS-RNTI |
| CSS | 2_2 (TPC comma | TPC-PxxCH- | | | |
| | nd) | RNTI | | | |
| CSS | 2_3(TPC for SRS) | TPC-SRS- | | | |
| | | RNTI | | | |

According to an embodiment of the present disclosure, the UE may monitor DCI and an RNTI corresponding thereto, the DCI and the RNTI being associated with DCI type 1_1 and DCI type 0_1 of a USS, in the P(S)cell scheduling Scell. Also, the UE may monitor only DCI and an RNTI corresponding thereto, the DCI and the RNTI being associated with DCI type 1_0 and DCI type 0_0 of a USS, in the P(S)cell, and may not monitor DCI and an RNTI corresponding thereto, the DCI and the RNTI being associated with other DCI type of the USS. That is, with respect to the DCI and the RNTI associated with DCI type 1_1 and DCI type 0_1 of the USS, the UE may perform monitoring in the P(S)cell scheduling Scell and may not perform PDCCH monitoring in the P(S)cell, so that it is possible to prevent monitoring from being concentrated in the P(S)cell.

[PDCCH Monitoring Offloading Option 2.]

According to another embodiment, the UE may monitor a USS and a part of a CSS in a P(S)cell scheduling Scell. In this case, the UE may monitor DCI and an RNTI for a USS and a part of a CSS in a P(S)cell. The UE may monitor DCI and an RNTI for a remaining part of the CSS and DCI and an RNTI for a USS in the P(S)cell scheduling Scell.

In this case, as legacy DCI formats 2_0 to 2_3 from among DCIs for the remaining part of the CSS do not have a CIF, a CIF field has to be introduced to the formats for transmission of the DCI formats in a Scell. When the UE detects the corresponding DCI format in the P(S)cell or the P(S)cell scheduling Scell, the UE may apply control information of DCI to a cell which is indicated by a CIF included in the corresponding format.

As another method, in a case of DCI type 2_0 to DCI type 2_3, there is a method of mapping allowed servingCell ID to corresponding DCI in an RRC reconfiguration message without a CIF. That is, after it is configured, via an RRC message, that a specific DCI type is allowed only in one specific cell, when the UE detects a DCI type corresponding thereto, the UE may apply the DCI type to a predefined cell.

Table 2 below indicates RNTIs the UE has to monitor for control information that may be transmitted via DCI type for each search space and DCI corresponding to the DCI type which may be transmitted in the P(S)cell and the P(S)cell scheduling Scell when the P(S)cell scheduling Scell is activated. The UE has to monitor an RNTI for application of information that may be transmitted with a DCI format and a DCI type which correspond to Table 2, in each cell (P(S)cell and P(S)cell scheduling Scell). Also, as indicated in Table 2, each DCI format and RNTI may correspond to a CSS and a USS. Here, SI-/P-/RA-RNTI among CSSs are available only in a P(S)cell, and DCI corresponding to DCI type 2_x and associated RNTIs are available both in a P(S)cell and a P(S)cell scheduling Scell.

TABLE 2

| P(s)Cell | | | PCell scheduling SCell | | |
|---|---|---|---|---|---|
| | DCI | | | DCI | |
| SS | format | RNTI | SS | format | RNTI |
| CSS | 1_0 | RA-RNTI | CSS | 2_0 | SFI-RNTI |
| CSS | 0_0 | T C-RNTI | CSS | 2_1 | INT-RNTI |
| CSS | 1_0 | P-RNTI | CSS | 2_1 | TPC-PxxCH-RNTI |
| CSS | 1_0 | SI-RNTI | CSS | 2_3 | TPC-SRS-RNTI |
| USS | 0_0, 1_0 | C-RNTI, | USS | 1_1, 0_1 | C-RNTI, CS-RNTI, |
| | | CS-RNTI, | | | MCS-RNTI |
| | | MCS-RNTI | | | |

According to an embodiment of the present disclosure, the UE may monitor DCI and an RNTI corresponding thereto, the DCI and the RNTI being associated with DCI type 1_1 and DCI type 0_1 of a USS, in the P(S)cell scheduling Scell. Also, the UE may monitor, in the P(S)cell scheduling Scell, DCI and an RNTI which are associated with a CSS. For example, a BS may add a CIF field with respect to DCI type 2_0 to DCI type 2_3 of the CSS, and the UE may monitor DCI and an RNTI which are associated with DCI type 2_0 to DCI type 2_3 of the CSS in the P(S)cell scheduling Scell, based on the added CIF field. As another example, the BS may map DCI to servingCell ID in an RRC reconfiguration message, the DCI being associated with DCI type 2_0 to DCI type 2_3. The UE may apply the DCI mapped to servingCell ID, based on the RRC reconfiguration message.

Also, the UE may monitor only DCI and an RNTI corresponding thereto, the DCI and the RNTI being associated with DCI type 1_0 and DCI type 0_0 of a USS, in the P(S)cell, and may not monitor DCI and an RNTI corresponding thereto, the DCI and the RNTI being associated with other DCI type of the USS. As the UE can perform monitoring of DCI and an RNTI associated with not only DCI type 1_1 and DCI type 0_1 of the USS but also DCI type 2_0 to DCI type 2_3 of the CSS in the P(S)cell scheduling Scell, a monitoring load in the P(S)cell may be decreased.

[Method of Configuring Search Space of P(S)Cell and P(S)Cell Scheduling Scell]

A BS may configure a search space for every bandwidth part (BWP) according to the PDCCH monitoring task distribution method. With respect to a P(S)cell and a P(S)cell scheduling Scell, when PDCCH configuration is performed on a DL BWP corresponding to servingCellConfig of each cell, the BS can configure all search space factors associated with a USS or a CSS with respect search spaces included in the PDCCH configuration, compared to a legacy case in which only search space ID configuration is performed. A plurality of pieces of configurable information corresponding thereto are as below.

Search space ID, CORESET ID, monitoring slot and periodicity and offset, duration, monitoring symbol within slot, number of candidate, a common search space or a UE specific search space as a search space type, and supported DCI type information of each USS/CSS.

In this case, an additional indicator as to whether it is configuration information to be used in Scell activation or configuration information to be used in Scell deactivation may be additionally included in information of a search space configured fora BWP.

[PDCCH Monitoring Operation of UE According to Performing/not-Performing of random access, according to PDCCH offloading method]

In a situation where configuration according to the offloading scheme and activation/deactivation configuration for a Scell are given,
the UE may perform a PDCCH monitoring operation in which the UE may first monitor all DCI types in a P(S)cell when a P(S)cell scheduling Scell is in a deactivate state. However, in a situation in which the P(S)cell scheduling Scell is in an activate state, the UE may differently operate according to a PDCCH monitoring offloading option. This case is a case in which deactivation of a Scell is allowed, and deactivation of a Scell is not always ensured as in [Operating method for activation/deactivation of P(S)cell scheduling Scell] mentioned above.

In [PDCCH monitoring offloading option 1.] mentioned above, when a random access is not performed, the UE may monitor DCI format 1_1, 0_1 and C-RNTI, CS-RNTI, MCS-RNTI while monitoring a PDCCH of a P(S)cell scheduling Scell. Then, when the UE monitors a PDCCH of a P(S)cell, the UE may monitor DCI format 2_0, SFI-RNTI, DCI format 2_1, INT-RNTI, DCI format 2_2, TPC-PxxCH-RNTI, DCI format 2_3, TPC-SRS-RNTI, DCI format 1_0, P-RNTI & SI-RNTI.

In a case of the option 1, when a random access is performed, a DCI format and an RNTI to be monitored may become different. When the random access is performed, the UE may monitor DCI format 1_1, 0_1 and C-RNTI, CS-RNTI, MCS-RNTI in the P(S)cell scheduling Scell, and may monitor DCI format 2_0, SFI-RNTI, DCI format 2_1, INT-RNTI, DCI format 2_2, TPC-PxxCH-RNTI, DCI format 2_3, TPC-SRS-RNTI, DCI format 1_0 P-RNTI & SI-RNTI & RA-RNTI, DCI format 0_0, T C-RNTI in the P(S)cell.

The DCI format and the RNTI are associated with each other, and DCI of a specific type may be decoded by its associated RNTI. In the above, concatenated DCI type and RNTI have corresponding association.

In contrast, in a case of [PDCCH monitoring offloading option 2.] mentioned above, when a random access is not performed, the UE may monitor DCI format 2_0, 2_1, 2_2, 2_3, and 1_1, 0_1 and SFI, INT, TPC-PxxCH, TPC-SRS-RNTI, C-RNTI, CS-RNTI, MCS-RNTI in the P(S)cell scheduling Scell. Concurrently, the UE may monitor DCI format 1_0, 0_0, and P-RNTI, SI-RNTI, C-RNTI, TC-RNTI, MCS-RNTI in the P(S)cell. However, when a random access is performed, the UE may monitor DCI format 2_0, 2_1, 2_2, 2_3, and 1_1, 0_1 and SFI, INT, TPC-PxxCH, TPC-SRS-RNTI, C-RNTI, CS-RNTI, MCS-RNTI in the P(S)cell scheduling Scell. Also, the UE may monitor DCI type 1_0, 0_0, and P-RNTI, SI-RNTI, C-RNTI, TC-RNTI, MCS-RNTI & RA-RNTI, and DCI type 0_0 and T C-RNTI in the P(S)cell.

[Method of Configuring Cross Carrier Scheduling in or after Scell Addition]

When the UE operates only a P(S)cell, a CrossCarrierSchedulingConfig field is not signaled in a ServingCellConfig field of the P(S)cell. Afterward, when a Scell is added, an RRCReconfiguration message including configuration for addition of the Scell may include a CrossCarrierSchedulingConfig field in a ServingCellConfig field of the P(S)cell and the Scell to be added. Configuration of a CrossCarrierSchedulingConfig field of the P(S)cell and the P(S)cell scheduling Scell may be as below.

Other field may be indicated in a schedulingCellInfo field included in the CrossCarrierSchedulingConfig field of the P(S)cell, and ID of the P(S)cell scheduling Scell may be indicated in the schedulingCellId field. Also, when a cif-InSchedulingCell field is not indicated as a carrier indicator field value indicating that it is a schedule of a P(S)cell which is scheduled when a P(S)cell scheduling Scell performs scheduling, and even when it is indicated as a natural number of 1 to 7 (option 1), or is indicated as a random integer number, the UE may identify 0 as a CIF of the P(S)cell (option 2).

The indicator is delivered, and own field may be indicated in schedulingCellInfo included in the CrossCarrierSchedulingConfig field of the P(S)cell scheduling Scell and a cif-Presence field may be set to true. Also, the cif-Presence field has to be set to true, and in a case of option 1 matching configuration of the P(S)cell, a CIF indicating the P(S)cell scheduling Scell may be 0. Also, in a case of option 2 matching configuration of the P(S)cell, a CIF indicating the P(S)cell scheduling Scell may be a natural number of 1 to 7 indicating serving cell id of a corresponding Scell.

The contents above are classified based on options as below. Each option is accompanied with operations of both a P(S)cell and a P(S)cell scheduling Scell.

Option 1. Other of P(s)cell->schedulingCellId indicates P(s)cell scheduling Scell id. cif-InSchedulingCell may not be indicated or may be a natural number of 1 to 7.

Own of scheduling Scell->cif-Presence may be a true value, and in this case, a CIF indicating a corresponding Scell may be 0.

When the UE monitors PDCCH DCI in a Scell, the UE checks a CIF value, and when the CIF value is 0, the UE may identify that a corresponding DCI type is for scheduling information of a P(S)cell scheduling Scell. The UE may identify that a CIF value other than that is scheduling information of a P(S)cell. Alternatively, when there is no CIF value, the UE may identify that corresponding DCI is scheduling information of a P(S)cell.

Option 2. Other of P(s)cell->schedulingCellId indicates P(s)cell scheduling Scell id, and even when a random natural number is indicated as cif-InSchedulingCell, 0 is identified as a CIF of a P(S)cell.

Own of scheduling Scell->cif-Presence: true value. In this case, CIF indicating a corresponding Scell is a natural number of 1 to 7 indicating serving cell id of the corresponding Scell.

In this case, when the UE monitors PDCCH DCI in a Scell, the UE checks a CIF value, and when the CIF value is a serving cell id value of itself, the UE may identify that a corresponding DCI type is scheduling information of a P(S)cell scheduling Scell. When the CIF value is 0, the UE may identify that it is scheduling information of a P(S)cell. Alternatively, when there is no CIF value, the UE may identify that corresponding DCI is scheduling information of a P(S)cell.

As another method, there is no change in ServingCellConfig information of a P(S)cell but an additional field is provided to a CrossCarrierScheduleConfig field included in a ServingCellConfig field of a Scell provided in Scell addition, such that it is possible to indicate that the Scell replaces scheduling of the P(S)cell. In this case, information that may be included in the added field may be a serving cell index of the P(S)cell to be scheduled and/or CIF value information indicating that it is for control of the P(S)cell.

With the method above, the UE may identify that schedule control information of the P(S)cell is received via another Scell, and when the UE monitors a PDCCH of a P(S)cell scheduling Scell, the UE may determine, by using a CIF value, whether the control information is for the P(S)cell scheduling Scell or a scheduled P(S)cell.

[Capability signaling method]

A UE signals an available capability, and thus, when a network configures a P(S)cell scheduling Scell according to necessity, the network may configure a corresponding feature with respect to a Scell available for the UE. When the UE transmits a UE capability report or an RRC message corresponding thereto to the network, the UE may indicate and transmit availability or not-availability for cases below by indicating a 1 bit indicator.
1 bit for availability or not-availability about FDD P(s)cell scheduling by FDD Scell,
1 bit for availability or not-availability about TDD P(s)cell scheduling by TDD Scell,
1 bit for availability or not-availability about TDD P(S)cell scheduling by FDD Scell,
1 bit for availability or not-availability about FDD P(s)cell scheduling by TDD Scell.

When receiving the report, the network may determine availability or not-availability, and may command P(S)cell scheduling of a Scell according to necessity. UE capability may be indicated as 1 bit per bandcombination. Alternatively, UE capability may be indicated as 1 bit for specific bandcombination defined in RAN4, and is not supported for other band combinations.

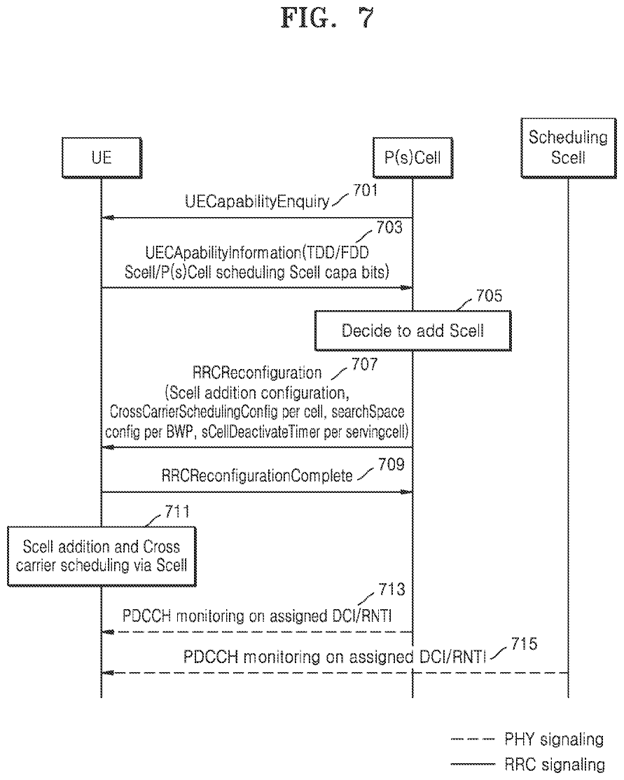

FIG. 7 is a flowchart of operations of a UE and a BS according to an embodiment of the present disclosure.

In operation 701, after the UE establishes connection with a P(S)cell, the UE may receive a UEcapabilityEnquiry message from a BS of the P(S)cell.

In operation 703, after receiving the message, the UE transmits its UE capability information to the BS, and in this regard, the UE may include the plurality of pieces of bit information about availability or not-availability about FDD/TDD and Scell/P(s)cell scheduling and may transmit them to the BS. A detailed operation thereof follows [Capability signaling method] described above.

In operation 705, after receiving the capability, the BS decides Scell addition, according to necessity.

In operation 707, accordingly, the BS may include configuration information necessary for the Scell addition in RRCReconfiguration and may transmit it to the UE. Afterward or with the RRCReconfiguration message including configuration for the Scell addition, the BS may indicate configuration of the Scell as a P(S)cell scheduling Scell.

Via the RRCReconfiguration message including configuration for the Scell addition or an RRCReconfiguration message thereafter, the BS may transmit configuration associated with cross carrier scheduling to the UE. Information therefor may be CrossCarrierSchedulingConfig configuration information for a P(S)cell and a P(S)cell scheduling Scell to be scheduled, search space configuration information configured for each BWP of each cell, and sCellDeactivateTimer configuration information configured for each serving cell. Configuration associated with cross carrier scheduling may follow [Method of configuring cross carrier scheduling in or after Scell addition] mentioned above.

As configuration information transmitted from the BS, the BS may transmit search space configuration information to the BS for each BWP of each cell. The configuration corresponding thereto may follow [Method of configuring search space of P(S)cell and P(S)cell scheduling Scell] mentioned above.

As configuration information transmitted from the BS, the BS may transmit sCellDeactivateTimer configuration information to the UE for each serving cell. This case may be a method of configuring sCellDeactivationTimer as absent for a P(S)cell scheduling Scell in [Operating method for activation/deactivation of P(S)cell scheduling Scell] mentioned above.

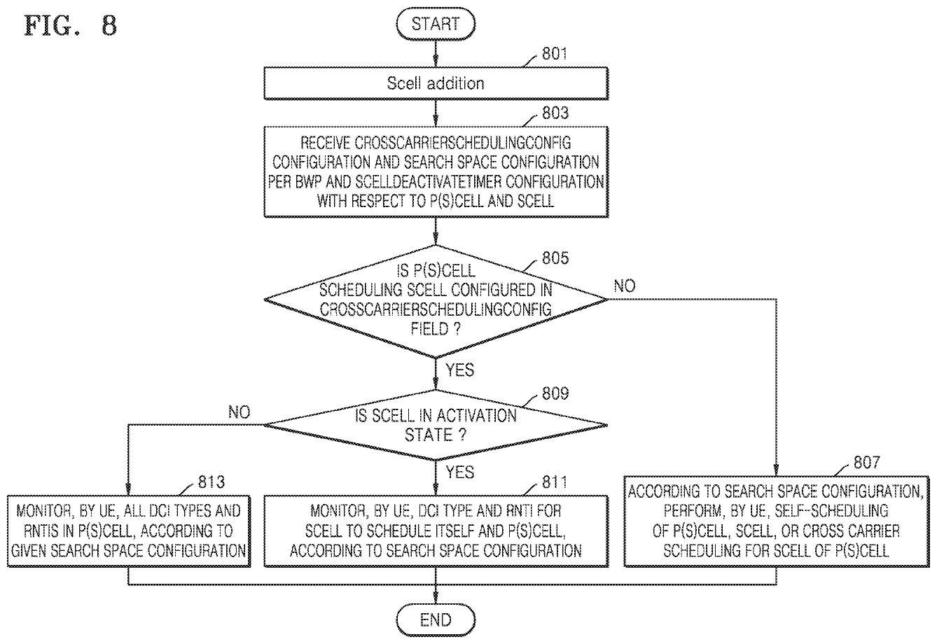

In operation 709, the UE may transmit an RRCReconfiguration Complete message to the BS of the P(S)cell. In operation 711, the UE may add a Scell, based on the RRCReconfiguration message, and may perform cross carrier scheduling via the Scell. Detailed descriptions related to operation 711 will be described below with reference to FIG. 8.

In operation 713 and operation 715, the UE having received a plurality of pieces of information configured by the BS may obtain configuration information of receivable DCI type for each cell, based on the received search space configuration information, may obtain a CIF or the like used in a P(S)cell and a P(S)cell scheduling Scell, and may monitor a DCI type and an RNTI of a corresponding search space in the P(S)cell and the P(S)cell scheduling Scell, according to the predefined offloading method for PDCCH monitoring offloading. The specific offloading method follows [PDCCH monitoring offloading option 1.] and option2 mentioned above. Also, while monitoring, when the Scell is deactivated or the UE performs a random access in the P(S)cell, a DCI type and a type of an RNTI to be monitored in the P(S)cell and the P(S)cell scheduling Scell may be changed, and this may follow [PDCCH monitoring operation of UE according to performing/not-performing of random access, according to PDCCH offloading method].

FIG. 8 illustrates a flowchart of operations of a UE according to an embodiment of the present disclosure.

In operation 801, the UE may add a Scell, based on an RRCReconfiguration message including configuration information for Scell addition.

In operation 803, after or at the same time when the UE adds the Scell, the UE may receive CrossCarrierSchedulingConfig configuration and search space configuration per BWP and SCellDeactivateTimer configuration with respect to a P(S)cell and the Scell.

In operation 805, the UE may determine whether a P(S)cell scheduling Scell is configured in a CrossCarrierSchedulingConfig field.

When the P(S)cell scheduling Scell according to [Method of configuring cross carrier scheduling in or after Scell addition] is not configured in the CrossCarrierSchedulingConfig field of the configuration information (‘NO’ in operation 805), in operation 807, according to search space configuration, the UE may perform self-scheduling of the P(S)cell and the Scell or may perform cross carrier scheduling for a Scell of the P(S)cell, and at this time, the UE may receive, from a BS, search space configuration information for Scell scheduling of the P(S)cell, such that the UE may monitor a DCI type and an RNTI in each cell or the P(S)cell.

If the P(S)cell scheduling Scell according to [Method of configuring cross carrier scheduling in or after Scell addition] is configured in the CrossCarrierSchedulingConfig field (‘YES’ in operation 805), in operation 809, the UE may additionally check whether a current Scell is in an activation state. If the Scell is in an activation state (‘YES’ in operation 809), in operation 811, the UE may monitor a DCI type and an RNTI for scheduling, on the Scell, the Scell itself and a P(S)cell, according to given search space configuration.

If the Scell is in a deactivation state in the checking of Scell activation (‘NO’ in operation 809), in operation 813, the UE may monitor all DCI types and RNTIs in the P(S)cell, according to given search space configuration.

The UE may monitor different DCI types and RNTIs in each cell, according to activation/deactivation of the Scell, while the cross carrier scheduling configuration information is given.

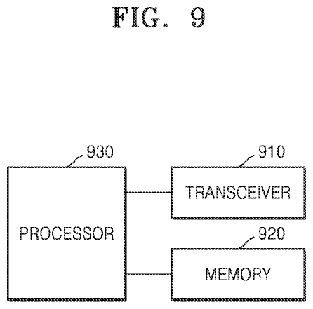

FIG. 9 is a block diagram illustrating a structure of a UE according to an embodiment of the present disclosure.

As illustrated in FIG. 9, the UE may include a transceiver 910, a memory 920, and a processor 930. According to the communication method of the UE described above, the processor 930, the transceiver 910 and the memory 920 of the UE may operate. However, elements of the UE are not limited to the example above. For example, the UE may include more elements than those described above or may include fewer elements than those described above. In addition, the processor 930, the transceiver 910 and the memory 920 may be implemented as one chip.

The transceiver 910 collectively refers to a receiver of the UE and a transmitter of the UE, and may transmit or receive signals to or from a BS or a network entity. The signals being transmitted or received to or from the BS may include control information and data. To this end, the transceiver 910 may include a RF transmitter for up-converting and amplifying a frequency of signals to be transmitted, and an RF receiver for low-noise-amplifying and down-converting a frequency of received signals. However, this is merely an example of the transceiver 910, and elements of the transceiver 910 are not limited to the RF transmitter and the RF receiver.

Also, the transceiver 910 may include a wired/wireless transceiver, and may include various configurations for transmitting and receiving signals.

Also, the transceiver 910 may receive signals via wired/wireless channels and output the signals to the processor 930, and may transmit signals output from the processor 930, via wired/wireless channels.

Also, the transceiver 910 may receive and output a communication signal to the processor, and may transmit a signal output from the processor to the network entity via a wired/wireless network.

The memory 920 may store programs and data required for the UE to operate. Also, the memory 920 may store control information or data included in a signal obtained by the UE. The memory 920 may include any or a combination of storage media such as read only memory (ROM), random access memory (RAM), a hard disk, a compact disc (CD)-ROM, a digital versatile disc (DVD), or the like.

Also, the processor 930 may control a series of processes to allow the UE to operate according to the embodiments of the present disclosure. Also, the processor 930 may include one or more processors. For example, the processor 930 may include a CP for controlling communications and an AP for controlling an upper layer such as an application program.

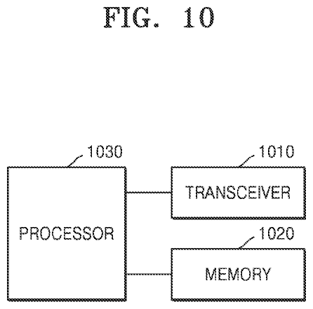

FIG. 10 is a block diagram illustrating a structure of a BS according to an embodiment of the present disclosure.

As illustrated in FIG. 10, the BS may include a transceiver 1010, a memory 1020, and a processor 1030. According to the communication method of the BS described above, the processor 1030, the transceiver 1010 and the memory 1020 of the BS may operate. However, elements of the BS are not limited to the example above. For example, the BS may include more elements than those described above or may include fewer elements than those described above. In addition, the processor 1030, the transceiver 1010 and the memory 1020 may be implemented as one chip.

The transceiver 1010 collectively refers to a receiver of the BS and a transmitter of the BS, and may transmit or receive signals to or from a UE or another BS. The signals being transmitted or received may include control information and data. To this end, the transceiver 1010 may include a RF transmitter for up-converting and amplifying a frequency of signals to be transmitted, and an RF receiver for low-noise-amplifying and down-converting a frequency of received signals. However, this is merely an example of the transceiver 1010, and elements of the transceiver 1010 are not limited to the RF transmitter and the RF receiver. Also, the transceiver 1010 may include a wired/wireless transceiver, and may include various configurations for transmitting and receiving signals.

Also, the transceiver 1010 may receive signals via communication channels (e.g., wireless channels) and output the signals to the processor 1030, and may transmit signals output from the processor 1030, via communication channels.

Also, the transceiver 1010 may receive and output a communication signal to the processor, and may transmit a signal output from the processor to the UE or the network entity via a wired/wireless network.

The memory 1020 may store programs and data required for the BS to operate. Also, the memory 1020 may store control information or data included in a signal obtained by the BS. The memory 1020 may include any or a combination of storage media such as ROM, RAM, a hard disk, a CD-ROM, a DVD, or the like.

Also, the processor 1030 may control a series of processes to allow the BS to operate according to the embodiments of the present disclosure. Also, the processor 1030 may include one or more processors. The methods according to the embodiments of the present disclosure as described herein or in the following claims may be implemented as hardware, software, or a combination of hardware and software.

According to an embodiment of the present disclosure, a method performed by a UE in a wireless communication system may be provided. The method may include receiving, from a BS, configuration information about CCS, when CCS from a Scell to a Pcell or a PScell is configured via the configuration information, monitoring a PDCCH of the Scell or a PDCCH of the Pcell or the PScell, and identifying scheduling information about the Pcell or the PScell, based on the monitoring.

According to an embodiment, the monitoring may include monitoring the PDCCH of the Pcell or the PScell in a CSS, the PDCCH including at least one of DCI format 0_0 or DCI format 1_0.

According to an embodiment, when the CCS from the Scell to the Pcell or the PScell is configured, the configuration information may include first CCS configuration information corresponding to the Pcell or the PScell and second CCS configuration information corresponding to the Scell, the first CCS configuration information may include a first parameter indicating that the Pcell or the PScell is to be scheduled by the PDCCH of the Scell, the second CCS configuration information may include a second parameter about self-scheduling indicating that the Scell is to be scheduled by the PDCCH of the Scell, the first CCS configuration may have a third parameter indicating an ID of the Scell and a fourth parameter indicating a CIF value used for the Scell to indicate the Pcell or the PScell, and the second parameter may include a fifth parameter indicating whether a CIF exists in a DCI format.

According to an embodiment, the fifth parameter may be configured to a true value indicating that the CIF exists in the DCI format.

According to an embodiment, when the fifth parameter is configured to the true value, the CIF value may be 0.

According to an embodiment, the CIF value indicated by the fourth parameter may be any one of 1 to 7.

According to an embodiment, when the CCS from the Scell to the Pcell or the PScell is configured, an operation of activation or deactivation of the Scell may be supported.

According to an embodiment, the monitoring may include, when the Scell is deactivated, monitoring the PDCCH of the Pcell or the PScell.

According to an embodiment of the present disclosure, a UE including a transceiver, and at least one processor coupled with the transceiver may be provided. The at least one processor may be configured to receive, from a BS, configuration information about CCS, when CCS from a Scell to a Pcell or a PScell is configured via the configuration information, monitor a PDCCH of the Scell or a PDCCH of the Pcell or the PScell, and identify scheduling information about the Pcell or the PScell, based on the monitoring.

According to an embodiment, the at least one processor may be configured to monitor the PDCCH of the Pcell or the PScell in a CSS, the PDCCH including at least one of DCI format 0_0 or DCI format 1_0.

When the CCS from the Scell to the Pcell or the PScell is configured, the configuration information may include first CCS configuration information corresponding to the Pcell or the PScell and second CCS configuration information corresponding to the Scell, the first CCS configuration information may include a first parameter indicating that the Pcell or the PScell is to be scheduled by the PDCCH of the Scell, the second CCS configuration information may include a second parameter about self-scheduling indicating that the Scell is to be scheduled by the PDCCH of the Scell, the first CCS configuration may have a third parameter indicating an ID of the Scell and a fourth parameter indicating a CIF value used for the Scell to indicate the Pcell or the PScell, and the second parameter may include a fifth parameter indicating whether a CIF exists in a DCI format.

According to an embodiment, the fifth parameter may be configured to a true value indicating that the CIF exists in the DCI format.

According to an embodiment, when the fifth parameter is configured to the true value, the CIF value may be 0.

According to an embodiment, the CIF value indicated by the fourth parameter may be any one of 1 to 7.

According to an embodiment of the present disclosure, a method performed by a BS in a wireless communication system may be provided. The method may include transmitting, to a UE, configuration information about CCS, and, when CCS from a Scell to a Pcell or a PScell is configured via the configuration information, a PDCCH of the Scell or a PDCCH of the Pcell or the PScell may be monitored, and scheduling information about the Pcell or the PScell may be identified, based on the monitoring.

The methods according to the embodiments of the present disclosure as described herein or in the following claims may be implemented as hardware, software, or a combination of hardware and software.

When implemented as software, a computer-readable storage medium which stores one or more programs (e.g., software modules) may be provided. The one or more programs stored in the computer-readable storage medium are configured for execution by one or more processors in an electronic device. The one or more programs include instructions directing the electronic device to execute the methods according to the embodiments of the present disclosure as described in the claims or the specification.

The programs (e.g., software modules or software) may be stored in non-volatile memory including random access memory (RAM) or flash memory, read only memory (ROM), electrically erasable programmable read only memory (EEPROM), a magnetic disc storage device, a compact disc (CD)-ROM, a digital versatile disc (DVD), another optical storage device, or a magnetic cassette. Alternatively, the programs may be stored in memory including a combination of some or all of the above-mentioned storage media. Also, a plurality of such memories may be included.

In addition, the programs may be stored in an attachable storage device accessible through any or a combination of communication networks such as Internet, an intranet, a local area network (LAN), a wide LAN (WLAN), a storage area network (SAN), or the like. Such a storage device may access, via an external port, a device performing the embodiments of the present disclosure. Furthermore, a separate storage device on the communication network may access the electronic device performing the embodiments of the present disclosure.

In the afore-described embodiments of the present disclosure, configuration elements included in the present disclosure are expressed in a singular or plural form according to the embodiments of the present disclosure. However, the singular or plural form is appropriately selected for convenience of descriptions and the present disclosure is not limited thereto. As such, a configuration element expressed in a plural form may also be configured as a single element, and a configuration element expressed in a singular form may also be configured as plural elements.

Specific embodiments are described in the descriptions of the present disclosure, but it will be understood that various modifications may be made without departing the scope of the present disclosure. Thus, the scope of the present disclosure is not limited to the embodiments described herein and should be defined by the appended claims and their equivalents. In other words, it will be apparent to one of ordinary skill in the art that other modifications based on the technical ideas of the present disclosure are feasible. Also, the embodiments may be combined with each other as required. For example, portions of the methods provided by the present disclosure may be combined with each other to enable the BS and the UE to operate. Also, although the embodiments of the present disclosure are described based on 5G and NR systems, modifications based on the technical scope of the embodiments of the present disclosure may be applied to other communication systems such as LTE, LTE-A, LTE-A-Pro systems, or the like.

1-15. (canceled)

16. A method performed by a user equipment (UE) in a wireless communication system, the method comprising:
receiving, from a base station, a radio resource control (RRC) message including a cross carrier scheduling (CCS) related configuration information, wherein in case that a CCS from a secondary cell (Scell) to a primary cell (Pcell) is configured, the Pcell is scheduled by a physical downlink control channel (PDCCH) on the Scell and a PDCCH on the Pcell; and
monitoring a PDCCH for receiving downlink control information (DCI), based on search space restriction information, wherein the PDCCH on the Scell and the PDCCH on the Pcell are not monitored simultaneously for receiving DCI associated with at least one search space on the Pcell.

17. The method of claim 16, wherein the at least one search space includes a common search space (CSS) for DCI format 1_0 or DCI format 0_0.

18. The method of claim 16, wherein in case that the CCS from the Scell to the Pcell is configured, search space related information is configured for the Pcell.

19. The method of claim 16, wherein the CCS related configuration information is associated with the PCell or the Scell.

20. The method of claim 16, wherein the CCS related configuration information includes:
a parameter indicating that the Pcell is scheduled by the PDCCH of the Scell;
a parameter indicating an identifier (ID) of the Scell; and
a parameter indicating a carrier indicator field (CIF) value used in the Scell.

21. The method of claim 20, wherein the CIF value is one among 1 to 7.

22. The method of claim 16, wherein the CCS related configuration information includes a self-scheduling related parameter indicating that the Scell is scheduled by the PDCCH of the Scell, and
wherein the self-scheduling related parameter includes a parameter indicating whether a carrier indicator field (CIF) value is present.

23. The method of claim 22, wherein in case that the CIF value is present, the CIF value is 0.

24. A user equipment (UE) in a wireless communication system, the UE comprising:
a transceiver; and
at least one processor coupled with the transceiver and configured to:
receive, from a base station, via the transceiver, a radio resource control (RRC) message including a cross carrier scheduling (CCS) related configuration information, wherein in case that a CCS from a secondary cell (Scell) to a primary cell (Pcell) is configured, the Pcell is scheduled by a physical downlink control channel (PDCCH) on the Scell and a PDCCH on the Pcell; and
monitor a PDCCH for receiving downlink control information (DCI), based on search space restriction information, wherein the PDCCH on the Scell and the PDCCH on the Pcell are not monitored simultaneously for receiving DCI associated with at least one search space on the Pcell.

25. The UE of claim 24, wherein the at least one search space includes a common search space (CSS) for DCI format 1_0 or DCI format 0_0.

26. The UE of claim 24, wherein in case that the CCS from the Scell to the Pcell is configured, search space related information is configured for the Pcell.

27. The UE of claim 24, wherein the CCS related configuration information is associated with the PCell or the Scell.

28. The UE of claim 24, wherein the CCS related configuration information includes:
a parameter indicating that the Pcell is scheduled by the PDCCH of the Scell;
a parameter indicating an identifier (ID) of the Scell; and
a parameter indicating a carrier indicator field (CIF) value used in the Scell.

29. The UE of claim 28, wherein the CCS related configuration information includes a self-scheduling related parameter indicating that the Scell is scheduled by the PDCCH of the Scell, and
wherein the self-scheduling related parameter includes a parameter indicating whether a CIF value is present.

30. A method performed by a base station in a wireless communication system, the method comprising:
transmitting, to a user equipment (UE), a radio resource control (RRC) message including a cross carrier scheduling (CCS) related configuration information, wherein in case that a CCS from a secondary cell (Scell) to a primary cell (Pcell) is configured, the Pcell is scheduled by a physical downlink control channel (PDCCH) on the Scell and a PDCCH on the Pcell; and
transmitting, to the UE, downlink control information (DCI) associated with at least one search space on the Pcell, based on search space restriction information, wherein the DCI associated with the at least one search space is not transmitted simultaneously via the PDCCH on the Scell and the PDCCH on the Pcell.
